(19) United States
(12) Patent Application Publication
(10) Pub. No.: US 2022/0412122 A1
(43) Pub. Date: Dec. 29, 2022

(54) ACTUATING HANDLE AND DEVICE FOR SECURING AGAINST BREAK-INS

(71) Applicant: Erich MATOUSCHEK, Bietigheim-Bissingen (DE)

(72) Inventor: Erich MATOUSCHEK, Bietigheim-Bissingen (DE)

(21) Appl. No.: 17/793,908

(22) PCT Filed: Dec. 9, 2020
(86) PCT No.: PCT/EP2020/085378

§ 371 Date: Jul. 19, 2022

(30) Foreign Application Priority Data
Jan. 21, 2020 (EP) 10 2020 000 322.2
Aug. 7, 2020 (EP) 10 2020 004 835.8

(51) Int. Cl. E05B 17/00; E05B 45/06

(52) U.S. Cl. CPC E05B 17/0066; E05B 45/06; E05B 2045/0615; E05B 2047/0067

(57) ABSTRACT

The invention relates to an actuating handle (17), provided with a preferably electromechanical locking mechanism (8, 8a), having a predetermined breaking point (4) which is between a handle neck (21) and a grip part (1) and is in particular monitored by an electrical switch (3) that preferably also acts as an “opening detector”. During authorised opening of the actuating handle (17), a programmed switch (A1) closes the circuit of the electrical switch (3), the circuit of the physical switch (A2) is then opened, and therefore the grip part (1) can be brought into an opening or tilted position without the alarm being triggered by the switch (3). After the actuating handle has been brought into the closure position, and after the electromechanical locking process (8, 8a), the switch (A1, A2) procedure is executed in a reverse sequence.

The invention relates to an actuating handle for operating a sash of a window or a door. Furthermore, the invention relates to a device for securing against break-in at an object which has at least one window and/or door with such an actuating handle. Embodiments of the invention relate in particular to a device for monitoring a window or a door against unlawful attacks.

In particular, embodiments of the invention relate to window handles with which window sashes can be actuated for opening, tilting, closing and locking.

For the technological background, reference is made to the following literature:
[1] EP 3 626 917 A1
[2] WO 2015/014978 A1
[3] DE 20 2015 008 986 U1
[4] U.S. Pat. No. 9,663,966 B1
[5] WO 2018/146460 A1
[6] DE 10 2010 018 780 B3
[7] DE 103 46 654 B3
[8] DE 10 2016 002 606 A1
[9] DE 296 03 917 U1
[10] US 2015/0 167 365 A1
[11] DE 198 33 834 A1
[12] EP 1 420 132 A1
[13] EP 1 318 254 A2

As can be seen from at least some of the foregoing literature, actuating handles are available in a wide variety of designs and assemblies. In most cases, a locking device is actuated by means of a handle as well as a mechanical connection that serves to lock, open or tilt an object opening.

Most of the burglaries take place through the window door, sliding door or via the window, and here through the locking mechanism. These are attacks by prying open the locking mechanism, attacks on the window handle directly, attacks on the gear, or attacks by levering the locking mechanism out of the locking plates. Often, the glass is smashed at the level of the window handle and the handle reached through the opening and turned to the open position. If the window handle is locked, it can be levered out of its lock and into the open position through the opening by means of a pry tool. Similarly, there are also some burglars who drill a hole through the window sash at the level of the window handle and lever even the locked window handle into the open position with a specially bent pry bar.

Currently, window handles lockable by means of a separate key are almost exclusively used both for purely mechanical security and also in burglar alarm systems against attacks on the locking mechanism of the window. These can be pried open and, as experience has shown, locking thereof is neglected after some time. However, getting the key, unlocking, airing, locking, removing the key and placing it out of reach several times a day becomes annoying over time. And, if nothing happens for a longer period, the keys are left in the locks or the handles are no longer locked at all for convenience.

To solve this problem and to prevent successful break-ins by tampering the window handle and turning it to the open position, various manufacturers have brought electromechanical window handles to the market which detect the position of the window handle and transmit this either independently, by radio or by cable to an external evaluation unit, usually an alarm panel. If no clearance for opening is programmed in this unit, an alarm is triggered in case of forcible actuation of the actuating handle. The program in the alarm panel is designed in such a way that the window can be opened at predefined times and otherwise remains locked. Example: the window handle disclosed in document [1].

This window handle is equipped with an electromechanical lock in the rosette. When the window handle is moved, a radio signal is sent to a smart home control center so that it knows which handle position this handle is in. A handle which is in the closed position, is automatically locked by the system—it can only be operated if the system gives the approval to open the windows within the parameters set by the user. If this is the case, the window handle is unlocked and it can be turned normally. This means that the times when locking is performed or the times in which unlocking is possible must be stored in the alarm center. If a window is to opened outside the programmed times, the lock must first be released via the smart home control center. This is not only inconvenient, but can also prevent employees or residents from escaping within the blocked time in the event of danger.

The window handle known from [1] also has a predetermined breaking point installed between the grip part and the square pin. If, in the locked state of the handle, a force greater than the predetermined breaking point is applied, the latter break. The handle can now be turned, but the window remains locked.

The invention is based on the problem of an actuating handle which, on the one hand, can be operated more easily and conveniently by the user than before, but which nevertheless offers greater security against break-ins.

This problem is solved by an actuating handle according to claim 1. A device for monitoring and securing an object against break-ins using one or more such actuating handles is stated in the further independent claim. Advantageous embodiments of the invention are the subject of the sub-claims. Furthermore, a corresponding method for monitoring and securing the object is provided.

In accordance with a first aspect thereof, the invention provides an actuating handle for actuating a sash of a window or a door comprising: a housing for attaching the actuating handle to the sash, a handle rotatably mounted to the housing and having a handle neck for gripping by a user, and a grip part supported in the housing for turning between a closed position and an open position for transmitting the turning movement of the handle to a locking mechanism of the sash, wherein at least one predetermined breaking point is provided between the handle neck and the grip part, a locking device by means of which the grip part can be locked in the closed position against rotation relative to the housing, and a breakage monitoring device for monitoring the predetermined breaking point and for outputting information about a breakage of the predetermined breaking point.

Preferably, the handle neck is formed with a grip area and an angled area oriented in the direction of rotation which is connected to the grip part via the predetermined breaking point. In other words, the handle neck is preferably of L-shaped or also U-shaped design.

Preferably, the handle neck, in particular the region oriented in the direction of the axis of rotation, is also supported in the housing.

Preferably, the predetermined breaking point is arranged in the housing.

Preferably, a rotational movement of the handle neck is monitored for monitoring the predetermined breaking point.

It is preferred that at least one fastening means for fastening the housing to the sash and a tamper protection device are provided, wherein the tamper protection device is arranged to detect a movement of the at least one fastening means and to output information about the movement of the fastening means. Since window sashes and their gears often have standardized threaded holes as fastening points for fastening the window handle, the fastening means are preferably designed as screws appropriately configured for engagement in such threaded holes.

It is preferred that the locking mechanism is of electromechanical design. In particular, the locking mechanism is designed such that it can be actuated signal-controlled or remotely controlled.

It is preferred that the locking mechanism has a latch actuable by an actuator for positive engagement in at least one latch recess on the grip part.

It is preferred that the locking mechanism is configured to be actuated by a monitoring center and/or by a switching unit and/or by an alarm system and/or by means of a time detection system.

It is preferred that a keyless personal identification device is provided, which is configured to initiate locking or unlocking of the grip part by the locking mechanism upon identification of an authorized person.

It is preferred that the personal identification device is selected from a group of personal identification devices comprising a biometric personal identification device for capturing a personal characteristic of the authorized person, a fingerprint recognition, a face or retina recognition, a voice recognition, a code button and an NFC interface or an RFID reader or the like for near field communication with a user terminal or a chip.

It is preferred that the fingerprint recognition is designed in such a way that one or more fingerprints are read in and stored in an internally or externally attached control unit by one or more authorized persons via a fingerprint scanner, which is either attached to/in the actuating handle or externally, and that an applied fingerprint is compared with the stored fingerprints either directly, by means of radio transmission or by cable.

It is preferred that the breakage monitoring device comprises a first sensor or a first switching unit for detecting a movement of the handle neck when the grip part is locked and is configured in such a way that, in the event of such a detection, it transmits information about the breakage to a control unit for triggering an alarm.

It is preferred that at least one circuit is provided which configured to bridge the first switching unit by means of a switching bridge when an authorized person is detected by the person identification device. The circuit is preferably accommodated in the housing, but it can also be provided externally and connected to electrical or electrotechnical units, switches, sensors or actuators in the housing in a wired or wireless fashion.

It is preferred that at least one switching bridge is installed between the control unit and the first switching unit.

It is preferred that the actuating handle configured in such a way that the switching bridge closes a circuit of the first switching unit when the authorized finger is placed on the fingerprint scanner before the authorized opening of the actuating handle, so that a switch of the first switching unit that can be actuated by moving the handle neck can open during the opening process of the actuating handle without providing the information about the break.

It is preferred that the electromechanical locking is unlocked after bridging.

It is preferred that the actuating handle, after it has been brought to the closing position, is locked electromechanically again.

It is preferred that when the grip part is automatically locked, the circuit switches, e.g. closes, a circuit of the first switching unit in such a way that a movement of the handle neck, in particular by a switch acting thereon, again provides the information about the breakage and that subsequently the at least one switching bridge opens again.

It is preferred that a status monitoring device for monitoring the status of the locking mechanism and for delivering information on the status to a monitoring center or to a control unit is provided.

It is preferred that the status monitoring device has a second switching unit or a second sensor for detecting the position of the locking mechanism, its latch or the position of the grip part.

It is preferred that at least one screw is provided as a fastening means for fastening the housing to the sash.

It is preferred that the tamper protection device comprises at least one switch engaging the screw, or a sensor detecting the screw or the other fastening means.

It is preferred that the screw has at least one area of larger diameter and one area of smaller diameter.

It is preferred that the tamper protection device is configured such that when an attempt is made to unscrew said screw to open or remove the actuating handle, a switch tongue of the switch is moved from the larger diameter to the smaller diameter of the screw or from the smaller diameter to the larger diameter of the screw, that through this movement a circuit is interrupted or closed by the switch as a result of the detected difference in diameter, and that in this way a tamper alarm is triggered by radio or in a wired fashion.

According to a further aspect, the invention relates to a device for securing an object against break-ins, which object comprises one or more windows and/or one or more doors, the sashes of which are at least partially equipped with an actuating handle according to any of the preceding claims.

The device preferably comprises at least one further opening detector, preferably comprising a reed switch with opposing magnets, for detecting a movement of the actuating handle or the sash provided therewith.

The device preferably comprises at least one glass breakage detector provided outside the actuating handle, which is connectable or connected to the actuating handle.

Preferably, the device comprises at least one further alarm detector connected or connectable to the actuating handle.

The device is preferably configured in such a way that sensitizing or desensitizing of an electronic monitoring unit is carried out via the automatic or signal-controlled locking mechanism, or that each individual actuating handle located in the object autonomously carries out sensitizing or desensitizing by means of the automatic or signal-controlled locking mechanism directly or via an external connection.

According to a further aspect, the invention provides a method for monitoring an object with regard to break-ins and for securing the object against break-ins, characterized by using an actuating handle or a device according to any of the preceding claims and triggering an alarm in case of breakage of the predetermined breaking point or at least one of several predetermined breaking points.

The said functions or steps of the individual units of the actuating handle or the device are implemented, for example, by software in the internal control unit or an external evaluation unit.

A preferred embodiment of the invention provides an actuating handle with a device for securing and monitoring a window or a door against unlawful attacks, wherein at least one electromechanical locking mechanism locks or unlocks the grip part of the actuating handle in the locked position against a rotary movement in the handle neck, and wherein at least one predetermined breaking point is provided between the grip part and the handle neck, wherein this predetermined breaking point is preferably monitored by at least one first electrical switching unit, in particular a first electrical switch.

Preferably, this first switching unit, preferably its first switch, is connected to at least one internal or external control unit. One embodiment of the actuating handle thus comprises the housing, the handle with handle neck, the grip part and predetermined breaking point, the breakage monitoring device and a control unit arranged outside or inside (the housing), which is correspondingly designed, in particular programmed, to perform the described functions by means of hardware or software.

This preferred embodiment described above functions in such a way that, in the locked state, an application of force to the grip part which is greater than the resistance of the predetermined breaking point leads to breakage of the predetermined breaking point, that the electrical switch transmits this to a monitoring unit, that there is now no longer any transmission of force between the grip part and the handle neck, with the electromechanical locking mechanism still being engaged.

An alarm can thus be triggered without the burglar entering the object.

In a particularly preferred embodiment of the invention, in order to prevent tampering from the inside, it is provided that the actuating handle is fastened to the window or to the door by means of a specially shaped screw, that a further electrical switch engages the screw and that the screw has in part a larger or smaller diameter. The tamper protection device preferably functions in such a way that when an attempt is made to turn this screw in order to open or remove the actuating handle, the switching tongue of the switch of the tamper protection device is moved from the larger diameter to the smaller diameter of the screw or from the smaller diameter to the larger diameter of the screw, that through this movement a circuit is either interrupted or closed by the switch as a result of the detected difference in diameter, and that in this way a tamper alarm is triggered by radio or by cable.

Generally speaking, the tamper protection device works with any fastening means whose movement can be detected by a corresponding switch or other sensor in order to trigger a message accordingly.

It is further preferred that the electromechanical locking and/or unlocking is performed by means of a switching device, an alarm system, a fingerprint reader and/or by means of a time detection system. Alternatively or additionally, other keyless, preferably biometric, personal identification devices are provided.

It is further preferred that one or more authorized persons can be identified by means of a print reader that is either attached to/in the actuating handle or externally, one or more fingerprints are read into an internally or externally attached control unit and stored, and that an applied fingerprint is compared directly with the stored fingerprints by means of radio transmission or in a wired fashion.

It is further preferred that when the authorized finger is placed on the print reader between the control unit and the fingerprint reader, at least one switching bridge is installed, which closes a circuit of the switch with a switching bridge prior to the authorized opening of the actuating handle, so that the switch can open during the opening process of the actuating handle, that the electromechanical lock is then unlocked, that after the actuating handle has been moved into the closed position, it is again electromechanically locked, that the circuit closes the circuit of the switch and that the switching bridges then open again.

It is further preferred that the respective state of the locking mechanism, unlocked or locked, is reported to a monitoring unit via a switch on the electromechanical locking mechanism.

It is further preferred that at least one further opening detector, preferably a reed switch with opposite magnets on or in the actuating handle, and/or at least one external glass breakage detector and/or further alarm detectors can be attached or connected.

It is further preferred that sensitizing or desensitizing of an electronic monitoring unit is carried out via the automatic locking mechanism, or that autonomously each single actuation device located in an object performs sensitizing or desensitizing directly or via an external connection by means of the automatic locking mechanism.

Particularly preferred embodiments of the actuating handle have the advantages of performing a unique identification directly on the handle element, permanently sensitizing this handle element, installing an electronically monitored predetermined breaking point and connecting it to an alarm center for transmitting an alarm in the event of a violent impact. Such particularly preferred embodiments allow this technology to be installed in highly vulnerable objects, such as banks, jewelry stores, etc.

Advantages and particular aspects of particularly preferred embodiments of the invention are explained in more detail below.

By means of a particularly preferred embodiment of the invention, it is possible to create an actuating handle which can also be used in high-security areas and which complies with the respective regulations, such as DIN VDE 0833 ff, VdS 2311 and others. In order to achieve this, in a particularly preferred embodiment of the invention, among other things, an electronically monitored predetermined breaking point, a special circuit in the evaluation unit, and a tamper protection device are installed on the handle element, in order to connect this to an alarm center for the transmission of an alarm in the case of a violent impact. This monitoring as well as an electromechanical locking and/or unlocking can take place by means of a switching device of an alarm system, a fingerprint reader and/or by means of a time recording system. In other embodiments, which are designed for less vulnerable areas, some of the aforementioned functions can be omitted.

When configuring preferred embodiments of the actuator handle, two different requirements must additionally be taken into account. Use thereof in dwelling areas should protect the residents around the clock. It is therefore advantageous if the monitoring technology can be sensitized around the clock. This contrasts with an application in the commercial sector. During the day, various people, some of them from outside the company, move around and have to leave the building as quickly as possible in the event of a dangerous situation. It is therefore advantageous for such applications if sensitizing only takes place after the last person has left.

These requirements can be met with embodiments of the actuating handle according to the invention.

A major advantage of the present invention is that a violent attack on the actuating handle, e.g. in the form of a window handle, results in the breakage of the predetermined breaking point, that an alarm is triggered, that the handle can then be turned without connection to the gear, and that the locking mechanisms in the window nevertheless remain locked.

Preferably, the electronic monitoring of the predetermined breaking point simultaneously serves as an “opening detector” in the sense of the regulations of the German Association of Damage Prevention VdS.

In preferred embodiments, a further switch is mounted on the mechatronic locking mechanism of the actuating handle. This switch informs a monitoring device, for example an alarm system, whether the actuating handle is locked against a rotary movement and thus whether the window or door is “locked” or not. A “locking detector” is prescribed by the VdS; this can also be achieved with such a design or another condition monitoring device for monitoring the condition of the locking mechanism.

In a sophisticated alarm monitoring system, secure tamper protection against tampering is required. For example, in an alarm-monitored commercial building that must be desensitized during the day because of escape possibilities, an impermissible, desensitized handle could be replaced by an ordinary window handle and later broken into via this window. To prevent this, an alarm-monitored screw fitting or other alarm-monitored fastening is used for tamper protection in a particularly preferred embodiment of the actuating handle.

Preferred embodiments create a window handle that triggers a tamper alarm when an attempt is made to unscrew at least one of the two fastening screws of the window handle.

In a particularly preferred embodiment, this is provided by a specially shaped and electronically monitored screw. Such a screw is shown in the following description and drawing.

Designs of the actuating handle according to the invention, such as in the form of a window handle, can also be used for the purely mechanical securing of an object without a connection to an alarm transmission system.

Further functions of particularly preferred embodiments of the actuating are apparent from the description.

In order to ensure that the technology on which the invention is based cannot be drilled through the sash from the outside and thus destroyed or disabled, a hardened steel plate, or better, a break-through monitoring plate or the like, can be placed between the rosette and the window sash.

In order to be able to visually determine the state of closure of the individual window in the event of presence, it would be advantageous if this were indicated by a red (open) or green (closed) diode on the actuating handle.

In the case of a burglar alarm system, VdS requires that the operator be notified when leaving the building whether all windows are closed and locked. As already mentioned, and as can be seen from the following drawings and description, the locking detector integrated in the preferred window handle is directly connected to a burglar alarm panel via the evaluation unit, so that when the operator leaves the building, sensitizing via the block lock or the like is only possible if all the object openings are closed and locked.

Another major advantage of the designs of the actuating handle, e.g. in the form of a window handle, with automatic user recognition, in particular via biometric features such as fingerprints, is that it no longer needs to be locked. In addition, the proposed window handle can be retrofitted into existing burglar alarm systems with all its advantages.

Intrusion panels (EMA) are frequently used for protection against intrusion. The requirements for such monitoring are different. In residential areas, for example, round-the-clock monitoring is required, unlike in commercial buildings. This cannot be achieved with the solution currently available on the market with “opening detectors”, which is the best variant, without triggering false alarms or considerably restricting the freedom of movement of the residents. The majority of false alarms are triggered in connection with sensitizing and desensitizing.

Preferred embodiments of the invention allow a decentralized solution in the living area, in which each window, each French window, and, technically modified, each door can be sensitized or desensitized independently of one another directly at each window, virtually for each window, each door, “one line”. With these preferred solutions, no false alarms are triggered by misbehavior or incorrect operation. In addition, due to the electronically monitored predetermined breaking point, any violent attack on the window handle leads to an alarm in advance and the window remains locked afterwards. In this way, an attacker is kept outside the object for some time after the alarm has been triggered, so that there is a possibility to prevent the attack by the intervention.

In order to achieve this, a keyless personal identification device is provided in preferred embodiments of the actuating handle, which is activated without a key, preferably biometrically with unique body characteristics of the authorized persons themselves, such as in particular fingerprints, or with devices or equipment that an authorized person usually carries with him or her, such as a smartphone, so that the aforementioned disadvantages of the solution requiring a key are avoided. Particularly preferably, a fingerprint reader and an internal control unit for automatic locking in the closed state and for release are installed in the rosette or in the grip part of the actuating handle for unambiguous identification. Authorized persons can read their fingerprints and store the algorithmic codes. Persons falling out of authorization can be deleted.

In a particularly preferred embodiment of the actuating handle, it is further envisaged that two switches connected in parallel are attached to the continuously sensitized, electronically monitored predetermined breaking point, which also acts as an “opening detector”. If the window is to be opened, a preferably keyless personal identification, in particular a biometric personal identification, is carried out, e.g. an authorized finger is placed on a fingerprint reader. If it is accepted, the first switch initially switches to “closed”. Then the window handle can be turned, with the second switch assuming the open position. In this way, by means of this circuit, the window handle is finally desensitized exclusively internally. This is not communicated to the intrusion panel. It is only informed by the locking detector installed in the window handle that the window has not been locked, but has not been overcome by force. If this window handle is brought into the locked position, it locks itself electromechanically, the “second switch” closes first, then the “first switch” opens, so that the monitoring of forced entry is seamless again. This handle unit thus acts decentralized, i.e. independently of an external release. If this window is closed again, the locking detector attached to the locking mechanism informs the control unit installed in the window handle and, via this, the intrusion panel.

This means that the window does not have to be removed from the burglar alarm system or other monitoring before it is opened and then added again when it is closed, as was previously the case.

The preferred window handle can be used, on the one hand, for integration into an electronic monitoring system and, differently equipped, for mechanical security, also with an internal siren.

In the preferred solution, each window, French door, sliding door, can be independently controlled via the identification system by means of a print reader or the like, connected to an electronic evaluation system, can be sensitized and desensitized, respectively, at each window directly, quasi for each window, each door, a “line”. The advantage of this solution is that all other windows that are not currently open are nevertheless permanently sensitized. This means that, for the first time, false alarm-free, round-the-clock protection is guaranteed, especially in properties where people want to move freely, such as in residential areas. In addition, this technology acts on behalf of people, so that false alarms caused by incorrect behavior or incorrect operation are virtually impossible. Thus, for the first time, people present as well as valuables are seriously protected around the clock. Another advantage is that a violent attack on the window handle causes the predetermined breaking point to break, that the alarm is triggered, and that the grip part can be turned then without any connection to the gear, and that the locking mechanisms in the window nevertheless remain locked. The electronic monitoring of the predetermined breaking point serves at the same time as an “opening detector” in the sense of the regulations of the German Association of Damage Prevention Vds.

The above-mentioned solution with personal identification, e.g. the print reader, is suitable for the electronic monitoring of at least some passages in a building in which strangers are also present, e.g. in commercial buildings where people must be able to escape at any time in the event of danger.

Here, preferably, no individualization by means of a print reader is used. In order to be able to use the advantages described above as far as possible, it makes sense to connect all such electronically monitored actuating handles without print readers or similar identification devices to a control center, preferably to a burglar alarm panel. Via this, the locking mechanisms can be activated when leaving the building by sensitizing and deactivated by desensitizing by a so-called block lock. Likewise, the locking detector integrated in the actuating handle can be used to determine whether all windows in the building are locked and monitored with the opening detector at the predetermined breaking point. The great advantage of this solution is that even in this handle variant the electronically monitored predetermined breaking point is also installed in this handle variant with the advantages already described.

The preferred window handle can also be used, without a connection to an alarm forwarding system and in a somewhat modified manner, for the mechanical, mechatronic securing of an object. This window handle, which is again equipped with a print reader, is constructed largely like the handle described above; it can also be the alarm-triggering component of the electronically monitored predetermined breaking point, possibly with an integrated siren that generates an internal alarm in the event of an attack.

Further features, details and advantages of the invention will be apparent from the wording of the claims and from the following description of exemplary embodiments with reference to the drawings. Features of embodiments of the invention are described in particular by the example of a window with a window handle as an actuating handle; however, the invention is not limited thereto. It is shown by:

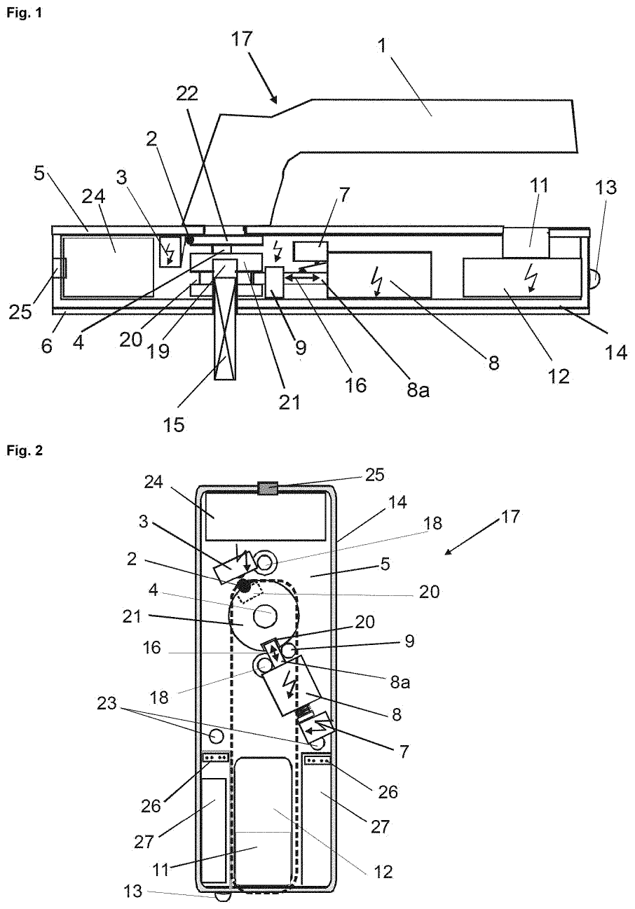

FIG. 1 a sectional view of one embodiment of an actuating handle with electronic monitoring;

FIG. 2 a top view of the actuating handle with electronic monitoring;

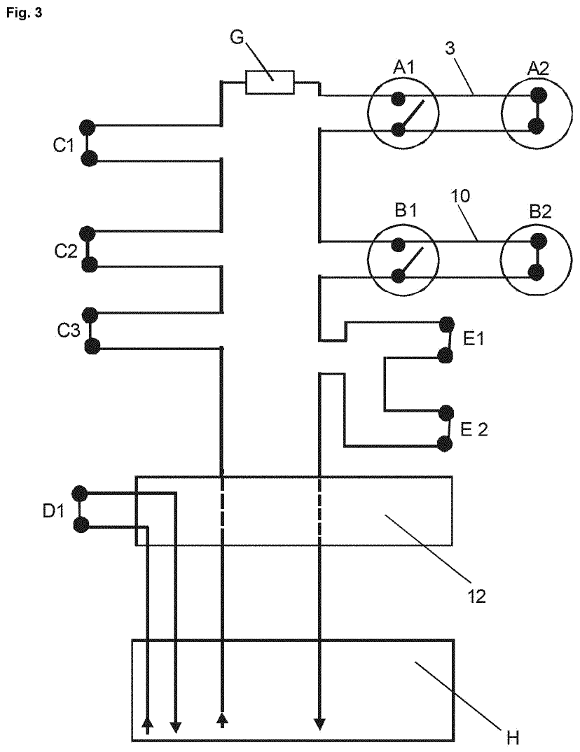

FIG. 3 one embodiment of a circuit diagram of the actuating handle mentioned in the above Figures; and

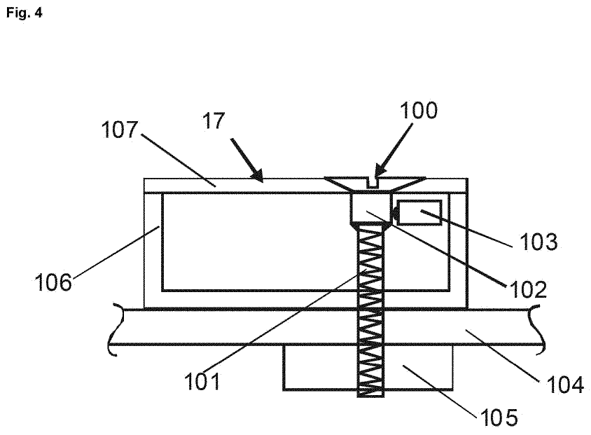

FIG. 4 a side view of an embodiment of a tamper protection device.

The device shown in a sectional view in FIG. 1 is used to detect and monitor the position of an actuating handle 17 and to transmit the detected position information to an evaluation unit, an alarm system, a bus system or the like.

The actuating handle 17 has, for example, a handle (window handle)—consisting of grip part 1 and handle neck 21—which is mounted on a stop body 14, for example a rosette, with a counter stop 22 so as to be axially fixed and rotatable. The actuating handle 17 is fastened by means of screws 101, 102, explained in more detail later with reference to FIG. 4, for example to a window sash, which is also not shown, wherein a driver 15, preferably a square pin, which is fixed in the neck of the handle 21 so that it cannot rotate, engages in a driver recess 19 adapted to the driver downstream of a predetermined breaking point 4 and then in an actuating device (gear) in the window sash, which is also not shown.

The predetermined breaking point 4 is checked for breakage by means of a breakage monitoring device described in more detail in the following by way of example.

In the handle neck 21 is a latch recess 20 (example of a latch counter-bearing). If the handle 1 is turned to the “locked” mode, a first switching unit 3 is closed. This is signaled by the first switching unit 3 to an electromechanical locking mechanism 8 mounted in the stop body 14, which now inserts a latch 8a into the latch recess 20 in the handle neck 21. This locks the rotary movement of the handle 1, 21. To achieve a higher locking effect, stabilizers 9 can be attached to the side of the latch 8a. When the latch 8a is locked into the latch recess 20, a second switching unit 7 signals this to a control unit 12 as “locked”.

The stop body 14 of the actuating handle 17 thus accommodates a number of electrical switching units 3, 7, which transmit the respective position of the handle 1, 21 by radio or by cable to the control unit 12 integrated in the actuating handle 17 or to an evaluation unit not shown.

The first switching unit 3 is located on a monitoring lug 2 and monitors the “closed” or “open” state of the actuating handle 17. It is, as seen from the handle—grip part 1—positioned upstream of the predetermined breaking point 4. If, in the closed state of the actuating handle 17, a force in excess of the resistance of the predetermined breaking point 4 is applied to the grip part 1, for example in the case of an attempted break-in, the predetermined breaking point 4 breaks.

This interrupts the transmission of force from the grip part 1 to the driver 15, the first switching unit 3 switches, signals this to the evaluation unit or control unit 12, the grip part 1 can now be operated without force connection to the driver 15, and the window remains locked in the locked state. This process can be reported by the evaluation unit or control unit 12 in the stop body 14 as an alarm to an alarm panel not shown. The first switching unit 3, with its special circuitry, is to be regarded as an “opening detector”.

The second electrical switching unit 7 installed on the stop body 14 is connected to the latch 8a and monitors the locked and unlocked state of the latch 8a. This respective state, locked or unlocked, shown with the arrow 16, is passed on by the second switching unit 7 to the evaluation unit or control unit 12, which can pass it on to the alarm panel, which is not shown, if required. The second switching unit 7 thus acts as a so-called “lock detector” for the alarm panel.

Diodes 13 can be attached to the stop body 14. These indicate to the operator via the closure detector whether the grip part 1 is locked or not locked via the electromechanical locking mechanism 8 in conjunction with the latch 8a.

A further advantageous design of the actuating handle 17 is that the actuating handle 17 is controlled by means of a fingerprint scanner 11—also called a print reader (preferred example of a biometric personal identification device). Either in the evaluation unit, the control unit 12 or in an external evaluation not shown, fingerprints of the authorized persons can be scanned. If a person subsequently places his or her finger on the fingerprint scanner 11, the algorithmic code is communicated to the respective evaluation unit and checked. If the authorized code is present, the grip part 1 is unlocked, in contrast to the unauthorized code. In other embodiments, other biometric personal identification devices that use at least one previously stored specific biometric feature of an authorized person, or a code input device for entering an authorization code, or an NFC receiver or a Bluetooth interface or the like for communication with a mobile communication device (in particular cell phone) stored as authorized, or an RFID reader can be provided. The personal identification system should be designed in such a way that it can perform identification based on features usually found on the person, such as biometric features, memorized codes or typically carried objects such as mobile phones or such as RFID chips to be used universally, so that no separate key needs to be kept or used and operation remains simple and convenient.

Fingerprint sensors are particularly preferred.

In order to detect tampering of the electronics in the actuating handle 17 from the outside, a drilling protection 6 can be installed between the window sash, which is not shown, and the stop body 14, or an alarm board can be installed instead.

If the actuating handle 17 is to be installed in objects in which there are also foreign persons are present, the solution involving the print reader or similar identification device should not be used for fire protection reasons, at least along escape routes. For such applications of the actuating handle 12, identification, for example by means of the print reader, is not required, and the control of the locking mechanism 8, 8a, can be taken over by an intrusion panel H or by another control unit. In this case, the locking mechanism 8, 8a, is out of action during the stay of the foreign persons and is activated only with sensitizing an electronic monitoring or the like. The advantage of this solution is that the electronically monitored predetermined breaking point 4 triggers an alarm in advance in the event of an unlawful attack and that the attacker is then kept outside the object by the locking mechanism, which is still engaged.

FIG. 2 shows a top view of the window handle—example of the actuating handle 17—for mechatronic protection against unlawful attacks.

The operation has already been shown in part in FIG. 1 and is described in detail in FIG. 2.

Shown is the grip part 1, which is fastened with the counter stop 22 in the stop body 14. In the closed position of the window, the monitoring lug 2 is located on the counter stop 22. The first switching unit 3 rests with its switching tongue or the like against the monitoring lug 2 in the closed state of the actuating handle 17, the actuating handle 17 thus being in the closed state.

If authorization to open the window via the actuating handle 17 is granted, the opening detector, the first switching unit 3, and possibly a further opening detector 10, which can be mounted in a recess or a free space 27 and connected via a connection 26 designed, for example, as a plug-in connection, are removed from the monitoring via the control unit 12, the electromechanical locking mechanism 8 is supplied with power for retracting the latch 8a, and the window can be opened via the grip part 1 without triggering an alarm. The switching details can be seen in FIG. 3. The required current is provided by an energy storage device such as a rechargeable battery 24, which can be charged via a charging connection 25.

Other details that can be learnt from FIG. 2, are the two stabilizers 9, which hold the latch 8a in the locked state against violent impact in engagement in the recess 20. This is advantageous, on the one hand, to achieve a higher resistance to the predetermined breaking point 4 and, on the other hand, to prevent an attacker from exposing the hardware on the window and attempting to lever the latch out of the strike plates.

Furthermore, FIG. 2 shows openings 18 through which the actuating handle 17 is fastened to the sash, which is not shown, by at least two screws 101, 102 or similar fastening means, preferably releasably. In order to make it more difficult to turn the grip part 1 even when the window is tilted, a further latch recess 20 for the latch 8a can be provided in the handle neck 21.

The locked or unlocked state can be indicated via diodes 13. In the base of the actuating handle 17 there are two apertures 23 through which a cable connection to a reporting center is made possible. The actuating handle 17 has a cover 5 which covers the electronics and the like.

If the actuating handle 17 is to be used exclusively for purely mechanical protection against unauthorized opening, the first switching unit 3 can be omitted. In this case, the actuating handle 17 is unlocked after the authorized fingerprint is placed on the fingerprint scanner 11 and after unlocking the latch 8a. In the case of the purely mechanical security system, the locked or unlocked state can also be indicated via diodes 13. In addition, a siren not shown in or outside the actuating handle can be actuated via the first switching unit 3.

FIG. 3 shows the circuit diagram of the actuating handle 17 referred to in the above Figures. For the high-security area, further detectors are connected to the actuating handle 17, in addition to the monitored predetermined breaking point 4, namely a reed contact with magnet 10, a glass breakage detector C1, an attack detector (e.g. drilling protection C1 or a detector which detects a lever open attempt in advance), and a tamper detector C2, here in particular designed as a tamper protection device 100, as will be explained in more detail below.

Switches A1 and A2 control the “opening detector”, first switching unit 3, at the electrically monitored predetermined breaking point 4.

At the first switching unit 3 (formed by the switches A1 and A2), in connection with the biometric identification, in particular print solution, the enormous advantage of the preferred design of the actuating handle 17 is evident. Together they are quasi the sensitizing and desensitizing and the monitoring of the individual windows against a break-in.

In the embodiment shown, the first switch A1, unlike the second switch A2, is not a physical switch but a programmed switch. In the locked state of the actuating handle 17, the second switch A2 of the first switching unit 3, which is designed as a mechanical switch, is closed and monitors the position of the actuating handle 17. If a previously authorized person places his/her finger on the fingerprint scanner 11 and is identified as authorized by the control unit 12, the programmed first switch A1 closes the contact to the first switching unit 3, the second switch A2 subsequently opens by actuating the actuating handle 17, whereby the latter can be turned to the open position without triggering an alarm due to the switching bridge of the first switch A1. If this window is integrated into a burglar alarm system, the actuating handle 17 can, from the point of view of the burglar alarm panel, be continuously sensitized without having to be desensitized before opening. If the window is closed again, the actuating handle 17 brought into the closed position, and the second switching unit 7 signals that the locking mechanism 8, 8a, is engaged, the procedure for switches A1 and A2 is carried out in reverse order. After this, the actuating handle 17 is again electronically monitored against unlawful attacks. The first switch A1 is thus a switching bridge for the duration of the opening of the actuating handle 17. False alarms due to incorrect operation can no longer be triggered with this procedure, since the technology acts for the operator, in contrast to current solutions.

The situation is similar if a further reed switch with an appropriately attached magnet is connected as an external “opening detector” 10 with the circuit B1 and B2. In the case that the actuating handle 17 is to be used up to the highest security classes, an absolutely secure closure detection must be carried out, as required by the German Association for Damage Prevention (VdS). Otherwise, an employee of a company, for example, could plan a theft and present it as a break-in. Without the external opening detector 10, which is e.g. a switching unit, this employee could override the faulty operation lock on the window sash, close a window only incompletely and move the handle to the locked position. The second switching unit 7 would then report a closure after the locking 8, 8a, which in this case only concerns the handle position. Therefore, an external switching unit as an opening detector 10 is preferable in designs of the actuating handle 17 which are configured for use in these safety classes.

As shown in FIG. 3, the external opening detector 10, like the second switching unit 3, is constructed as a switching unit with a first switch B1, in particular in the form of a programmed switch, and a second switch B2, in particular in the form of a physical switch, these switches B1, B2 of the external opening detector 10 also being connected in parallel. The switching units 3 and 10 are programmed in such a way that after closing the second switch A2 of the first switching unit 3, both the switching bridge (of the first switch A1) and the switching bridge at B1 are opened. In the case described here, the physical second switch B2—in particular designed as a REED contact—would still be open at this time on the external opening detector 10, since this is not applied against the corresponding magnet.

In this case, this external opening detector 10 would immediately trigger an alarm and in this way prevent incorrect operation or manipulation.

The major advantage of this solution described above is that all windows of an object are and can remain continuously sensitized and that only the window to be opened in each case after the authorization check is removed from sensitized state for the duration of opening. After the window is closed, it automatically and independently returns to the sensitized mode.

A connection of the electronically monitored actuating handle 17 to an intrusion panel H is advantageous. When connected to an intrusion panel H (EMZ), the second switching unit 7 (designed in the form of a lock monitoring unit D1 according to FIG. 3) exclusively indicates the opening status when the window is opened. The first switching unit 3 (with switches A1, A2) indicates, however, that the window has not been forced open but has been opened with authorization. Therefore, this process is not evaluated as an alarm, but is only registered by the EMZ to the effect that not all windows are closed when leaving the object. This is communicated to the operator when leaving by the fact that he cannot switch the block lock or the like.

In the circuit diagram, further detectors can be connected, for example a glass breakage detector at C1, a tamper detector at C2 and a drilling protection or the like at C3. If these detectors are to be mounted outside the actuating handle, tamper protection is required, e.g. in such a way that a 4-wire cable is connected to these detectors, with two wires connected to the tamper line E1 and, if necessary, to E2. In the sophisticated electronic intrusion protection, at least a 4-wire cable with cables of the same color is used. To prevent bridging attempts for removing a detector in this way from monitoring, the so-called Z-wiring is used, at the end of which a line end resistor G is attached. If an attempt is made to bridge the wires, the resistance thus changes, which is detected by the alarm panel and reported as an alarm. All the detectors shown above are monitored by the integrated evaluation unit 12. It only reports an illegal attack to the alarm panel. An exception is the lock detector—second switching unit 7—which is shown as D1 in the circuit diagram of FIG. 3. It has several functions. On the one hand, it informs the electromechanical locking mechanism 8, 8a and the intrusion panel H of the closure and, on the other hand, it controls the diode 13 attached to the stop body 14. Here the locking or opening status are indicated to the operator.

In the following, FIG. 4 is used to explain an example of one embodiment of a housing 106 of the actuating handle 17 with a tamper protection device 100. As shown in FIGS. 1 and 2, both parts 1, 21 of the handle are rotatably mounted in the housing 106. Accordingly, also the predetermined breaking point 4 and the breakage monitoring device are accommodated in the housing 106. The tamper protection device is arranged to detect a movement of the at least one fastening means with which the housing 106 is fastened to the sash of the window or door and to report accordingly, e.g. via the connection C2.

FIG. 4 shows in a side view an exemplary embodiment of the tamper protection device 100. One Embodiment of the tamper protection device 100 for protection against unlawful removal of the actuating handle 17 by means of an electronically monitored special screw 101, 102 is illustrated in a side view.

Illustrated is the housing 106 of the window handle 1, 21 (not shown in FIG. 4) and the cover 5, 107, which is fastened by the special screw 101, 102 through the housing 106 as well as by the window overlap 104 in the screw thread of the gear 105. The special screw 101, 102 has a threaded portion and a larger diameter portion 102 where the switching tongue of an electrical switch 103 engages in the assembled state. Since tamper monitoring is to be continuous here, the electrical switch 103 is in continuous monitoring mode, i.e., switched to non-stop operation.

When an attempt is made to unscrew the electrically monitored special screw 101, 102, the switching tongue of the electric switch 103 slides from the larger part of the diameter 102 of the special screw towards the part of smaller diameter 101 of the special screw, the switching tongue of the switch 103 thereby interrupting or switching the circuit. This is reported to the evaluation unit not shown—e.g. in particular to the control unit 12—whereupon an alarm is triggered.

Thus, an actuating handle (17) has been described, provided with a preferably electromechanical locking mechanism (8, 8a) having a predetermined breaking point (4) which is between a handle neck (21) and a grip part (1) and is in particular monitored by an electrical switch (3) that preferably also acts as an “opening detector”. During authorized opening of the actuating handle (17), a preferably programmed switch (A1) closes the circuit of the electrical switch (3), then the circuit of a preferably physical switch (A2) is opened so that the grip part (1) can be brought into the open or tilted position without the alarm being triggered by the switch (3). After the actuating handle has been brought into the closed position, and after the electromechanical locking (8, 8a), the procedure of the switches (A1, A2) takes place in the reverse sequence.

### LIST OF REFERENCE SIGNS

1 grip part
2 monitoring lug
3 first switching unit (as opening detector)
4 predetermined breaking point
5 cover
6 drilling protection
7 second switching unit (as locking detector)
8 electromechanical locking mechanism
8a latch
9 stabilizers
10 additional (e.g. external) opening detector
11 fingerprint scanner
12 control unit
13 diodes (whether closed or open)
14 stop body
15 driver
16 movement of lock
17 actuating handle
18 openings, e.g. for screws for fastening the actuating handle
19 driver recess (e.g. for a square pin)
20 latch recess (for latch 8a)
21 handle neck
22 counter stop
23 aperture for a cable connection
24 battery
25 charging connection for battery
26 connection for opening or glass breakage detector
27 free space for opening or glass breakage detector
A1 first switch, in particular in the form of a programmed switch, on the internal opening detector (first switch unit, on the predetermined breaking point)
A2 second switch, in particular in the form of a physical switch, on the internal opening detector (at the predetermined breaking point)
B1 first switch, in particular in the form of a programmed switch, on the external opening detector 10
B2 second switch, in particular in the form of a physical switch, on the external opening detector 10
C1 glass breakage detector
C2 tamper detector
C3 drilling protection (signaling plate)
D1 lock monitoring
E1 tamper line for the glass breakage detector
E2 tamper line for the external opening detector
G line end resistor
H intrusion panel
100 tamper protection
101 screw thread
102 enlarged diameter of the screw
103 electrical switch
104 window sash
105 gear of the fitting
106 housing
107 cover

1. An actuating handle for actuating a sash of a window or a door, comprising:
a housing for attaching the actuating handle to the sash;
a handle rotatably mounted on the housing and having a handle neck for gripping by a user and a grip part supported in the housing for rotation between a closed position and an open position for transmitting the rotational movement of the handle to a locking mechanism of the sash, at least one predetermined breaking point being provided between the handle neck and the grip part;
a locking mechanism by means of which the grip part is configured be locked against rotation relative to the housing in the locked position; and
a breakage monitoring device for monitoring the predetermined breaking point and for outputting information about a breakage of the predetermined breaking point.

2. The actuating handle according to claim 1, further comprising:
at least one fastening means for fastening the housing to the sash; and
a tamper protection device,
wherein the tamper protection device is configured to detect a movement of the at least one fastening means and to output information on the movement of the fastening means.

3. The actuating handle according to claim 1, wherein the locking mechanism is of electromechanical design.

4. The actuating handle according to claim 1, wherein the locking mechanism has a latch configured to be actuated by an actuator, for positive engagement in at least one latch recess on the grip part.

5. The actuating handle according to claim 1, wherein the locking mechanism is configured to be actuated by a monitoring panel and/or by a switching unit and/or by an alarm system and/or by means of a time recording system.

6. The actuating handle according to claim 1, further comprising a keyless personal identification device which is configured to initiate locking or unlocking of the grip part by the locking mechanism when an authorized person is identified.

7. The actuating handle according to claim 6, wherein the personal identification device is selected from the group of personal identification devices consisting of a biometric personal identification devices for detecting a personal characteristic of the authorized person, a fingerprint recognition, a face or retina recognition, a voice recognition, a code keypad, an NFC interface for near field communication with a user terminal or a chip, and an RFID reader.

8. The actuating handle according to claim 7, wherein the fingerprint recognition device is configured in such a way that one or more fingerprints of one or more authorized persons are read into and stored in an internally or externally mounted control unit by means of a fingerprint scanner that is either attached to/in the actuating handle or externally and that an applied fingerprint is compared directly with the stored fingerprints by means of radio transmission or in a wired manner.

9. The actuating handle according to claim 1, wherein the breakage monitoring device has a first sensor or a first switching unit for detecting a movement of the handle neck when the grip part is locked and is configured in such a way that, in the event of such detection, it supplies information about the breakage to a control unit for triggering an alarm.

10. The actuating handle according to claim 9, further comprising at least one circuit, which is configured to bridge the first switching unit by means of a switching bridge when an authorized person is detected by the personal identification device.

11. The actuating handle according to claim 10, wherein at least one switching bridge is installed between the control unit and the first switching unit,
wherein, when the authorized finger is placed on the print reader, the switching bridge closes a circuit of the first switching unit before the authorized opening of the actuating handle to allow a switch of the first switching unit to open when the actuating handle is opened, without delivering the information about the breakage,
wherein thereafter the electromechanical locking mechanism unlocks,
wherein after the actuating handle is again brought into the closed position, it is again electromechanically locked,
wherein, in the process, the switch closes the circuit, and
wherein subsequently the at least one switching bridge opens again.

12. The actuating handle according to claim 1, further comprising a status monitoring device for monitoring the status of the locking mechanism and for supplying information about the status to a monitoring panel or control unit.

13. The actuating handle according to claim 12, wherein the status monitoring device comprises a second switching unit or a second sensor for detecting the position of the locking mechanism its latch or the position of the grip part.

14. The actuating handle according to claim 2, further comprising, as fastening means, at least one screw for fastening the housing to the sash,
wherein the tamper protection device has at least one switch engaging the screw,
wherein the screw has at least one portion of larger diameter and one portion of smaller diameter,
wherein the tamper protection device is configured in such a way that, when an attempt is made to unscrew this screw in order to open or remove the actuating handle, the switching tongue of the switch is moved from the larger diameter to the smaller diameter of the screw or from the smaller diameter to the larger diameter of the screw,
wherein through this movement a circuit is interrupted or closed by the switch as a result of the detected difference in diameter, and
wherein in this way a tamper alarm is triggered by radio or in a wired fashion.

15. A device for securing an object against break-ins, wherein the object comprises one or more windows and/or one or more doors, the sashes of which are at least partially equipped with the actuating handle according to claim 1.

16. The device according to claim 15, further comprising at least one further opening detector, which comprises a reed switch with opposing magnets for detecting a movement of the actuating handle or of the sash provided therewith.

17. The device according to claim 15, further comprising at least one glass breakage detector provided outside the actuating handle and connectable or connected to the actuating handle.

18. The device according to claim 15, further comprising at least one further alarm detector which is connected or connectable to the actuating handle.

19. The device according to claim 15, wherein sensitizing or desensitizing of an electronic monitoring unit is performed via the automatic or signal-controlled locking mechanism, or autonomously each individual actuating handle located in the object performs the sensitizing or desensitizing by means of the automatic or signal-controlled locking mechanism directly or via an external connection.

20. A method for monitoring an object with regard to break-ins and for securing the object against break-ins, characterized by using the actuating handle according to claim 1 and triggering an alarm in the event of breakage of the predetermined breaking point or at least one of a plurality of predetermined breaking points.
